(19) United States
(12) Patent Application Publication
(10) Pub. No.: US 2026/0270860 A1
(43) Pub. Date: Sep. 10, 2026

(54) PROBING ACCESS POINTS IN A PRIVACY ENHANCED NETWORK

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Federico LOVISON, Fontanelle (IT); Jerome HENRY, Pittsboro, NC (US); Javier I. CONTRERAS ALBESA, Sant Cugat del Valles (ES)

(21) Appl. No.: 19/559,835

(22) Filed: Mar. 6, 2026

Related U.S. Application Data
(60) Provisional application No. 63/768,794, filed on Mar. 7, 2025.

(51) Int. Cl. H04W 48/20; H04W 12/084

(52) U.S. Cl. CPC H04W 48/20; H04W 12/084

(57) ABSTRACT

The present disclosure provides techniques for providing probing data in a privacy enhanced network, including receiving, at a first access point (AP) and from a first wireless station (STA) connected to the first AP, an information request associated with a second AP, where the first AP and the second AP are Basic Service Set (BSS) Privacy Enhancement (BPE) APs. The first AP may determine probing data associated with a first probing BSS identifier (BSSID) of the second AP. The first AP may transmit a first response comprising the probing data to the first wireless STA. The first AP may receive, from a second wireless STA connected to the second AP, a probe request for a second probing BSSID of the first AP, where the probe request comprising an authorization token. Based on successfully validating the probe request, the first AP may transmit a probe response to the second wireless STA.

### CROSS-REFERENCE TO RELATED APPLICATIONS

This application claims benefit of co-pending United States provisional patent application Serial No. 63/768,794 filed Mar. 7, 2025. The aforementioned related patent application is herein incorporated by reference in its entirety.

### TECHNICAL FIELD

Embodiments presented in this disclosure generally relate to wireless networks. More specifically, embodiments disclosed herein relate to probing non-associated access points in enhanced-security wireless networks.

### BACKGROUND

Modern wireless networks may employ a number of security features aimed at enhancing the security of the network and its clients. Basic Service Set (BSS) privacy enhancements (BPE) and Client Privacy Enhancement (CPE) techniques enable various BSSs, and clients therein, to preserve privacy and avoid outside tracking of the network, such as through attempting to anonymize identifiers of various devices in the network, such as access points (APs) or wireless stations (STAs), by changing identifiers, or by refraining from transmitting publicly broadcast or publicly available frames.

That is, a BPE-enabled AP may not send regular beacons or respond to standard probe requests. Instead, the AP may send one or more privacy beacons, which are new frames introduced in the IEEE 802.11bi amendments, wherein the BSS identifier (BSSID) of each AP is temporal and randomized, and wherein the payload is short and encrypted. While STAs associated with a given AP (e.g., pre-configured with a key) may decrypt the local AP private beacons, STAs have no mechanism to discover neighboring APs and their parameters, given the absence of standard beacons and probe requests.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for privacy enhanced wireless network management, according to some embodiments of the present disclosure.

FIG. 2 depicts an example environment for identifying probing data information in a privacy enhanced wireless network, according to some embodiments of the present disclosure.

FIG. 3 is a flow diagram depicting an example method for responding to information requests and probe requests from a wireless station in a privacy enhanced wireless network, according to some embodiments of the present disclosure.

FIG. 4 is a flow diagram depicting an example method for transmitting probing data to a wireless station in a privacy enhanced wireless network, according to some embodiments of the present disclosure.

FIG. 5 is a flow diagram depicting an example method for responding to probe requests in a privacy enhanced wireless network, according to some embodiments of the present disclosure.

FIG. 6 is a flow diagram depicting an example method for a wireless station to transmit probing requests in a privacy enhanced wireless network, according to some embodiments of the present disclosure.

FIG. 7 Is a flow diagram depicting an example method for forwarding probe requests over a distribution system in a privacy enhanced wireless network, according to some embodiments of the present disclosure.

FIG. 8 is a flow diagram depicting an example method for responding to probe requests in a privacy enhanced wireless network, according to some embodiments of the present disclosure.

FIG. 9 depicts an example network device configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method. The method includes: receiving, at a first access point (AP) and from a first wireless station (STA) connected to the first AP, an information request associated with a second AP, wherein the first AP and the second AP are Basic Service Set (BSS) Privacy Enhancement (BPE) APs; determining, by the first AP, probing data associated with a first probing BSS identifier (BSSID) of the second AP; transmitting, by the first AP, a first response comprising the probing data to the first wireless STA; receiving, from a second wireless STA connected to the second AP, a probe request for a second probing BSSID of the first AP, the probe request comprising an authorization token; and based on successfully validating the probe request, transmitting, by the first AP, a probe response to the second wireless STA.

Other embodiments provide an access point comprising one or more memories and one or more processors communicatively coupled to the one or more memories, wherein the one or more processors are configured to, individually or collectively, perform the aforementioned method, as well as those described herein; and a non-transitory computer readable storage medium comprising instructions that when executed configure one or more processors of an access point to perform the aforementioned methods as well as those described herein.

### EXAMPLE EMBODIMENTS

In some embodiments of the present disclosure, techniques are provided to identify BSSID information of neighboring APs in an Extended Service Set (ESS) featuring a set of BPE-enabled APs.

Many wireless deployments are comprised of Basic Service Sets, each comprising one AP and various wireless STAs connected to the AP. An Extended Service Set connects multiple BSSs together, in turn comprising multiple APs from across the connected BSSs. In this way, wireless STAs may be able to roam between different BSSs of the ESS without losing connectivity.

However, in modern BPE-enabled networks, APs may periodically change (e.g., at a random or set frequency) visible parameters, such as a BSSID, in an attempt to anonymize the network and prevent identification and tracking of the AP(s) and client(s) by outside actors. Similarly, APs may refrain from broadcasting beacons, and/or may refrain from responding to standard probe requests. Instead, the APs may transmit a privacy beacon, wherein the BSSID is temporal and randomized, and wherein the payload is short and encrypted, such as containing only a Traffic Indication Map (TIM) and a reduced number of parameters, such as those required to tell a STA if a BSSID configuration of the AP has changed.

While this may result in increased security for the network, the resulting network is such that connected STAs (e.g., those associated to an AP) may decrypt the privacy beacons of the respective AP, while having no mechanism of discovering neighboring APs (e.g., those residing in a different BSS than the STA).

Embodiments of the present disclosure provide methods, systems, and apparatuses for providing a manner for a STA to probe neighboring APs throughout a privacy enhanced ESS. More specifically, some embodiments are directed towards techniques enabling a network device (e.g., an AP) to identify probing data, such as a temporal probing BSSID of a neighboring AP and an associated authorization token, and provide that data to a STA. The STA may then use the probing data to transmit a probing request to the neighboring AP, and, if the request is valid, receive a probe response in return. Such techniques enable an ESS to benefit from the enhanced privacy and security offered by BPE without facing issues associated with probing across various BSSs.

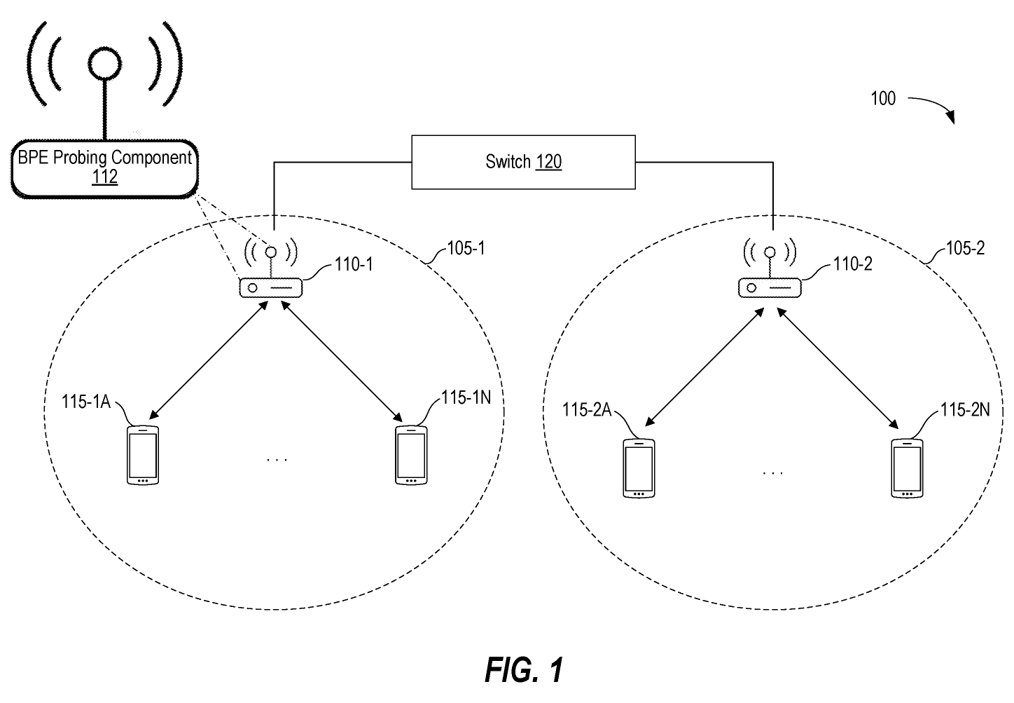

FIG. 1 depicts an example wireless environment 100 in which embodiments of the present disclosure may be implemented. As depicted, the environment 100 includes multiple Basic Service Sets 105-1 and 105-2 (collectively, “BSSs 105”), connected by a switch 120 to form an Extended Service Set. Although the Extended Service Set of FIG. 1 is depicted as including only two BSSs, any number of BSSs may be included in other implementations.

Each of the BSSs 105 may include an AP, such as an AP 110-1 and an AP 110-2 (collectively, “APs 110”). Each AP 110 may generally correspond to an access point used to facilitate or provide connectivity in a wireless network (e.g., a wireless local area network (WLAN), e.g., using Wi-Fi protocols) and implement a BSS. Each respective AP 110 may be identified throughout the ESS with a respective unique BSSID, which wireless STAs may use to connect to and send data throughout a corresponding BSS.

Each of the APs 110 may provide wireless access to one or more wireless STAs (e.g., client devices), such as a collection of STAs 115-1A through STAs 115-1N or a collection of STAs 115-2A through STAs 115-2N (collectively, “STAs 115”). Each of STAs 115 may generally be representative of any computing device capable of wireless communications using the WLAN, such as a smartphone, tablet, laptop, wearable computing device (e.g., smartwatch), and the like.

Each of the APs 110 may be associated with any number of the associated set of STAs 115 for active wireless data communications. For example, as depicted, the STA 115-1A is associated with the AP 110-1. In some embodiments, each of the APs 110 may be concurrently connected to any number of client devices. In some embodiments, each AP 110 may operate as a single-link AP or as a multi-link device (MLD) AP, and each STA 115 may operate as a single-link station (STA) or as an MLD STA.

In some embodiments, any (or all) of the APs 110 may be a BPE-capable AP, such that the AP is capable of implementing BSS privacy enhancement techniques, such as changing BSSIDs periodically or transmitting one or more privacy beacons. For example, the AP 110-1 may be a BPE-capable AP, wherein the AP 110-1 operates or otherwise uses one or more probing BSSIDs, at which the AP 110-1 may accept probe requests from a STA, such as STA 115-2A, in response to validating the request.

That is, in conventional privacy enhanced systems and networks, the APs 110 may be configured to not respond to probe requests from STAs 115, such as those stations residing in a different BSS than the AP receiving the request. For example, in a conventional system, the AP 110-1 may be configured to not respond to, or otherwise deny, a probe request received from the STA 115-2A.

However, according to embodiments of the present disclosure, any of the APs 110 may be configured (e.g., using a BPE probing component 112) to determine probing data that can be provided to a requesting STA 115, which may in turn be used to send a probe request to another of the APs 110. That is, any of the STAs 115 may communicate with an associated AP 110 to request and/or receive probing data (e.g., probing information) related to a neighboring AP 110 in the ESS. The BPE probing component 112 of the AP 110 receiving the request may determine probing data based on the request and may transmit the probing data back to the requesting STA 115. The probing data may include elements such as the probing BSSID, as described above, that a neighboring AP 110 may be configured to use to accept probing requests, or an authorization token that may be included in a probe request to “validate” the probe request. The requesting STA 115 may then use the probing data to transmit a probe request to a neighboring AP 110, which may validate the request and, if valid, transmit a probe request response to the requesting STA 115.

As one example, the STA 115-1A may transmit a probing Neighbor Report Request to the AP 110-1 to identify information about surrounding APs and identify an AP to reassociate with (e.g., to roam to). In response, the AP 110-1 may transmit a Neighbor Report Response to the STA 115-1A, with probing data for a neighboring AP (e.g., the AP 110-2), including a probing BSSID of the AP 110-2 and an authorization token. The STA 115-1A may use the authorization token to transmit a probe request to the probing BSSID of the AP 115-2, which may validate the request using the token and, in some examples, additional factors such as a source address of the request. If the request is deemed valid, the AP 115-2 may respond with a probe request response to the STA 115-1A.

As another example, the STA 115-2A may transmit a probe request to the AP 110-2, wherein the probe request is targeted at a neighboring AP, such as the AP 110-1. The AP 110-2 may transmit the probe request to the AP 110-1 (e.g., along a backhaul link between the APs 110), which may generate a probe request response. The AP 110-1 may transmit the probe request response to the AP 110-2, which may transmit the response to the STA 115-2A.

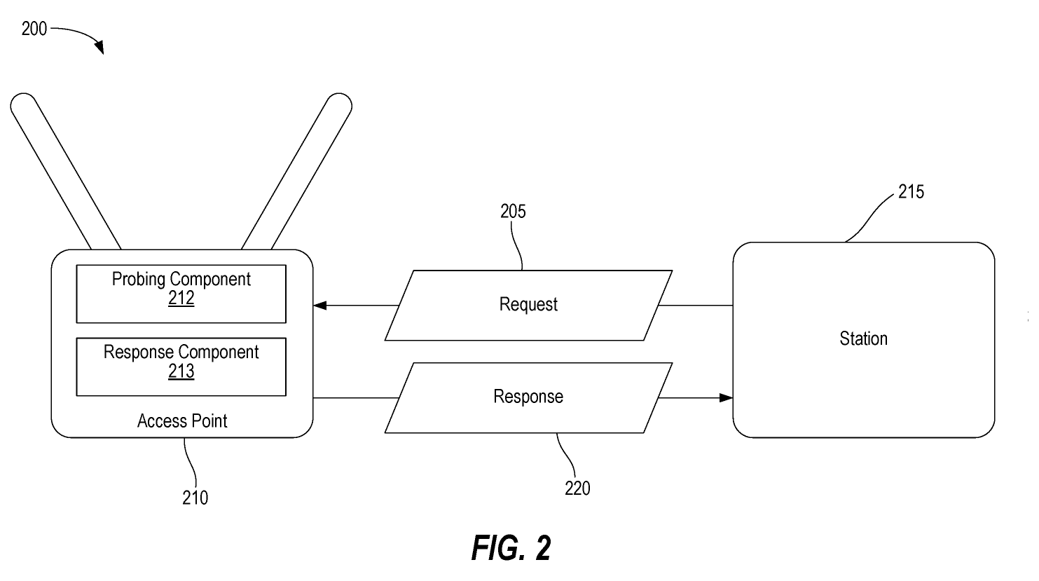

FIG. 2 depicts an example environment 200 for identifying probing data information in a privacy enhanced wireless network, according to some embodiments of the present disclosure. In the illustrated example, an AP 210 (which may correspond to one of the APs 110 of FIG. 1) is communicatively coupled with a STA 215 (which may correspond to one of the STAs 115 of FIG. 1), such as via a WLAN (e.g., a Wi-Fi network). That is, the AP 210 and the STA 215 may correspond to any of the APs 110 of FIG. 1 and an associated STA of the STAs 115, respectively, such that the AP 210 and the STA 215 may be a part of the same BSS, which in turn may be a part of a larger ESS. Accordingly, the probing component 212 may correspond to, and operate in a similar manner to, the BPE probing component 112 of FIG. 1.

In the environment 200, the STA 215 transmits a query 205 to the AP 210. For example, the STA 215 may transmit the query 205 via an action frame, or other non-routable data frame. The query 205 may generally correspond to, or comprise, a request for the AP 210 to provide probing data (e.g., probing information) to the STA 215 about any neighboring APs in the same ESS as the AP 210 (e.g., the AP 110-2 of FIG. 1). For example, the query 205 may be a Neighbor Response Request. In response to receiving the query 205, the AP 210, in conjunction with a probing component 212 and a response component 213, may determine and transmit probing data for one or more neighboring APs of the AP 210.

The probing component 212 may determine probing data for one or more neighboring APs of the AP 210. In some examples, the probing component 212 may determine a probing BSSID which a neighboring AP may use to accept a probe request (e.g., from the STA 215). The probing BSSID may be temporal, such that the probing BSSID changes after the passage of a specific or random period of time. In some examples, the probing component 212 may determine an authorization token. The authorization token may be used (e.g., by the associated neighboring AP) to validate a probe request including the authorization token.

The probing data may include the authorization token, the probing BSSID, or a combination thereof. When an item is absent from the response, the STA 215 may have one or more additional methods of acquiring any missing and necessary information. For example, the probing data may not include an authorization token, and the APs 210 of the ESS may be configured to derive an authorization token using some defined mechanism (e.g., based on the current temporal probing BSSID of the AP). That is, if the STA knowns the probing BSSID value, the STA may calculate or generate the token value directly, based on the probing BSSID (using the defined algorithm or mechanism). Conversely, in an example wherein the probing data does not include a probing BSSID, an authorization token may serve as a key used to compute the probing BSSID of a neighboring AP.

In other examples, the STA 215 may obtain an authorization token over one or more out-of-band mechanisms, such as obtaining the token from an application, cloud service, or other controller or management component. In some examples, the STA 215 may obtain the authorization token by proving that the STA currently resides (or is located) within a certain distance threshold of the BSS(s) that the STA 215 wants to probe. For example, the STA 215 may provide a location via the out-of-band mechanism, to the management entity, which may determine whether the location falls within a geographic radius or threshold of the neighboring AP. If the STA 215 falls within the radius, the management entity may (via the out-of-band mechanism) provide the STA 215 with the authorization token, while if the STA 215 does not fall within the radius, the management component may not provide the STA 215 with the authorization token (e.g., refraining from responding, sending an response indicating the issue and not including the token, etc.).

In some examples, the probing data may include additional elements. In some examples, the probing component 212 may determine a validity time related to a probing BSSID, such that the validity time indicates how long a neighboring AP will accept a probe request (using the given probing BSSID). For example, the probing component 212 may determine a validity time of three seconds, such that the associated AP will only respond to a probe requested received via the probing BSSID in the next three seconds. In some examples, the probing component 212 may determine a source address, such as a source address that the STA must or should use to transmit a probe request from a neighboring AP’s probing BSSID. For example, the neighboring AP may only respond to a probe request if the probe request is received from the specified source address.

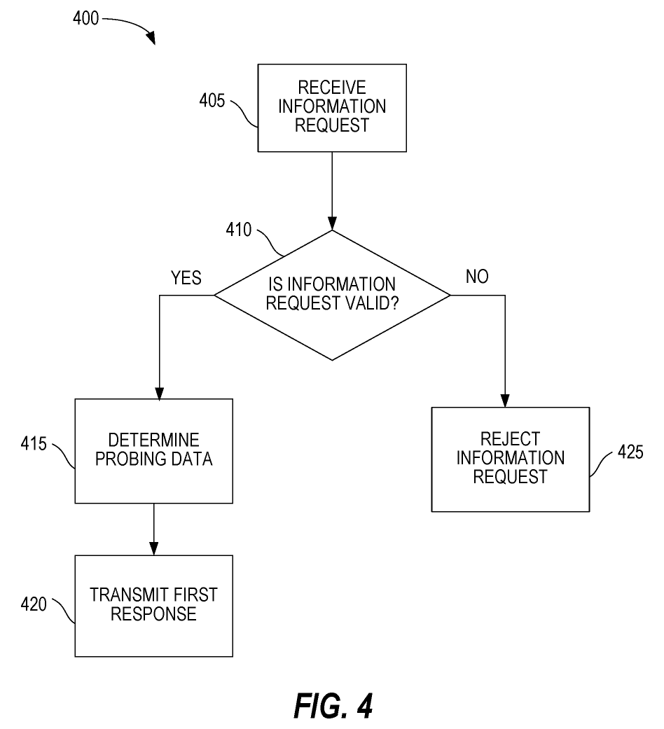

The response component 213 may encode and/or transmit a response 220 to the STA 215. The response 220 may be, or may include, one or more wireless management frames, wherein the management frame includes a neighbor report element associated with one or more neighboring APs and includes the probing data, as discussed above. In some examples, the probing component 212 may be configured to validate the query 205 before the response component 213 transmits the response 220, with validation techniques described in more detail below, with respect to FIG. 4.

In some examples, instead of a request for probing data, the query 205 may include a probe request itself. That is, the STA 215 may transmit a probe request to the AP 210, which the AP 210 may be configured to process and forward to neighboring AP(s) such that the STA 215 does not need to transmit the probe request directly to a target neighboring AP. For example, the STA 215 may transmit a probe request (e.g., the query 205) to the AP 210, wherein the probe request is targeted at a neighboring AP. The AP 210 may forward (e.g., transmit) the probe request to the target AP, which may generate a probe request response. The target AP may then forward (e.g., transmit) the probe request response to the AP 210, which may transmit the probe request response as, or as part of, the response 220 to the STA 215.

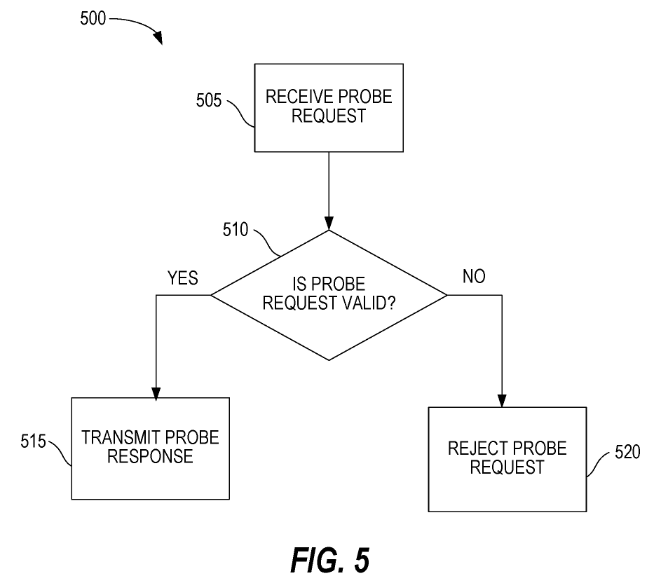

As described herein with respect to FIG. 2, the AP 210 and the STA 215 are described as being connected, such that the STA 215 is associated with the AP 210, and such that the AP 210 and the STA 215 reside in the same BSS (e.g., a BSS 105 of FIG. 1). However, in other examples, the AP 210 and the STA 215 may not be connected (e.g., wherein the AP 210 resides in a different BSS than the STA 215), In such examples, the probing component 212 and/or the response component 213 may be configured to operate differently than as described above. For example, the probing component 212 may be configured to generate probe request data, in response to receiving the query 205 (e.g., a probe request) from the STA 215. As another example, the probing component 212 may validate the query 205 (e.g., a probe request) as described above, such as by validating an authorization token or determining whether the query 205 is from a specific source address. The validation techniques in such examples are described in more detail below, with respect to FIG. 5.

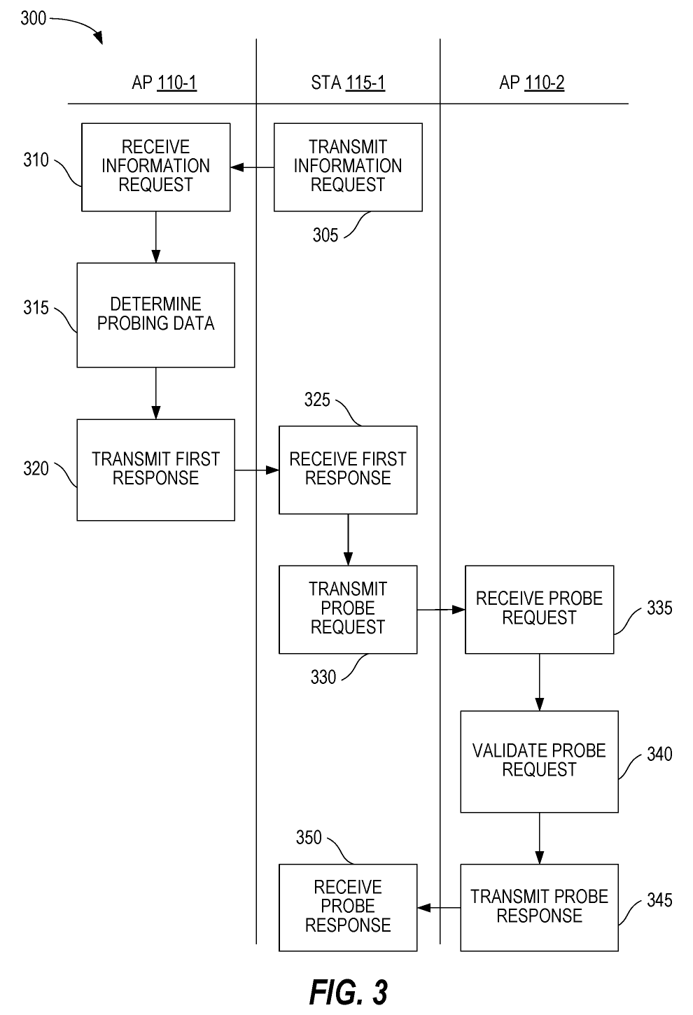

FIG. 3 depicts an example method 300 for responding to information requests and probe requests from a wireless station in a privacy enhanced wireless network, according to some embodiments of the present disclosure. As depicted in FIG. 3, the example method 300 is performed by the AP 110-1, the AP 110-2, and the STA 115-1 of FIG. 1. However, in other examples, the method 300 may be performed by any STA, such as any other STA 115 of FIG. 1 or the STA 215 of FIG. 2, and any two APs residing in separate BSSs (e.g., two different BSSs 105 of FIG. 1). Similarly, as depicted in the example method 300 of FIG. 3, the AP 110-1 is depicted as receiving an information request and generating probing data, while the AP 110-2 is depicted as receiving and responding to a probe request. However, in other examples, such as when the STA is connected to the AP 110-2 (e.g., any of the STAs 115-2), the AP 110-2 may receive an information request and generate probing data in response, while the AP 110-1 may receive and respond to a probe request.

At block 305, the STA 115-1 transmits an information request to the AP 110-1, to which the STA 115-1 is associated. In some aspects, the information request may be, or may include, a neighbor report request, and may generally correspond to a request to receive probing data (e.g., probing information) related to one or more other APs in the ESS (e.g., the AP 110-2). At block 310, the AP 110-1 receives the information request.

At block 315, the AP 110-1, or a component therein (e.g., the BPE probing component 112 of FIG. 1) determines probing data based on the information request. In some examples, the AP 110-1 may determine a probing BSSID at which the AP 110-2 may accept a probe request from the STA 115-1. The probing BSSID may be temporal, such that the probing BSSID changes after the passage of a specific or random period of time. In some examples, the AP 110-1 may determine an authorization token. The authorization token may be used by the AP 110-2 to validate a probe request including the authorization token. At block 320, the AP 110-1 transmits a first response, including the probing data, to the STA 115-1. In some examples, the probing data may include additional elements, such as a source address or a validity time. Blocks 310, 315, and 320 are described in greater detail below, with respect to FIG. 4.

At block 325, the STA 115-1 receives the first response comprising the probing data from the AP 110-1. The STA 115-1 may use the first response to generate a probe request for the AP 110-2. For example, the probe request may be directed to the probing BSSID determined based on the probing data, and/or include a source address or an authorization token indicated by the probing data received from the AP 110-1. At block 330, the STA 115-1 transmits the probe request to the AP 110-2 (e.g., using the probing BSSID indicated by the probing data).

At block 335, the AP 110-2 receives the probe request from the STA 115-1. At block 340, the AP 110-2 validates the probe request using one or more validation checks, based on factors such as a source address indicated by the probe request, a time at which the probe request is received, an authorization token included (or not included) in the probe request, and the like. Based on validating the probe request, at block 345, the AP 110-2, or a component therein (e.g., the response component 213 of FIG. 2), transmits a probe response to the STA 115-2. Blocks 335, 340, and 345 are described in greater detail below, with respect to FIG. 5.

At block 350, the STA 115-1 receives the probe response from the AP 110-2. The STA 115-1 may use the data indicated by the probe request to take one or more actions, such as initiating a roam to the AP 110-2, or another AP not depicted in the example method 300 of FIG. 3., transmitting an additional probe request to another AP not depicted in the example method 300, determining to stay connected to the AP 110-1, and the like.

FIG. 4 is a flow diagram depicting an example method 400 for transmitting probing data to a wireless station in a privacy enhanced wireless network, according to some embodiments of the present disclosure. In some embodiments, the method 400 is performed by an AP, such as an AP 110 of FIG. 1 and/or an AP 210 of FIG. 2. FIG. 4 may describe the blocks 310, 315, and 320 of FIG. 3 in greater detail.

At block 405, the AP (e.g., the AP 110 of FIG. 1 and/or an AP 210 of FIG. 2) receives an information request from a STA (e.g., any of the STAs 115 of FIG. 1 associated with the AP, and/or the STA 215 of FIG. 2). As described above, the information request may be, or may include, a neighbor report request, and may generally correspond to a request to receive probing data (e.g., probing information) related to one or more neighboring APs. In some examples, the information request may identify an AP, while in other examples, the information request may not identify an AP (e.g., such that the receiving AP determines which APs probing data should be determined for, as discussed below).

At block 410, the AP, or a component therein (e.g., the BPE probing component 112 and/or the probing component 212 of FIG. 1 and FIG. 2, respectively) determines if the information request is valid or invalid. Depending on the implementation, the AP may validate the information request according to a wide variety of different criteria. For example, in one implementation, the AP may determine a location of the requesting STA, and a location of a neighboring AP associated with the information request. The AP may determine a geographic radius (e.g., a threshold radius) around the neighboring AP, such that the AP determines that the information request is invalid if the requesting STA does not fall within the radius of the neighboring AP.

If the AP determines that information request is valid (e.g., successfully validates the information request), the AP proceeds according to the “YES” branch to block 415. At block 415, the AP determines probing data for the neighboring AP, as described above. In addition to the probing BSSID and/or authorization token, as discussed above with reference to block 315 of FIG. 3, in some examples, the probing data may include a validity time (e.g., a time to live) during which the neighboring AP associated with the probing data will accept probing requests at the current probing BSSID. That is, the validity time may indicate a duration of time during which the probing BSSID is valid. As another example, the probing data may include a source address, or an address at which the STA should transmit a probe request to the neighboring AP from. At block 420, the AP, or a component therein (e.g., the response component 213 of FIG. 2) transmits a first response to the requesting STA. In some examples, the first response may include a neighbor report element containing the probing data. In some examples, the first response may be, may include, or may be included in, a wireless management frame transmitted to the STA.

Returning to block 410, if the information request is invalid, the AP proceeds according to the “NO” branch to block 425. At block 425, the AP rejects the information request. In some examples, rejecting the information request may include the AP refraining from responding to the information request (e.g., not responding to the information request). In other examples, rejecting the information request may include sending a response, wherein the response does not include the probing data. In such examples, in some examples, rejecting the information request may include transmitting an error message, such as a message indicating why the information request was determined to be invalid.

FIG. 5 is a flow diagram depicting an example method for responding to probe requests in a privacy enhanced wireless network, according to some embodiments of the present disclosure. In some embodiments, the method 500 is performed by an AP, such as an AP 110 of FIG. 1 and/or an AP 210 of FIG. 2. FIG. 5 may describe the blocks 335, 340, and 345 of FIG. 3 in greater detail.

At block 505, the AP e.g., the AP 110 of FIG. 1 and/or an AP 210 of FIG. 2) receives a probe request from a STA (e.g., any of the STAs 115 of FIG. 1 associated with the AP, and/or the STA 215 of FIG. 2). As described below, in some examples, the AP may receive the probe request at a temporal BSSID (e.g., a probing BSSID, as discussed above with respect to FIGS. 3 and 4).

At block 510, the AP, or a component therein (e.g., the BPE probing component 112 of FIG. 1 or the probing component 212 of FIG. 2) determines whether the probe request is valid. That is, the AP may validate the probe request across a number of validity checks, including checking for the presence of, and validating, authorization tokens, determining whether the probe request was received within a certain time frame, and the like. As one example, the AP may determine whether the probe request was received at the appropriate BSSID and, in some examples, channel. That is, the AP may determine whether the probe request was received at the probing BSSID, or an alternate BSSID (e.g., an invalid BSSID). The AP may also determine if the probe request was received at the appropriate channel, as indicated by the probing data discussed with respect to FIGS. 2-4. For example, the AP may accept probe requests to the probing BSSID only over a specified channel (e.g., channel 36), such that requests to other channels are deemed invalid, even when the probing BSSID is correct.

As another example, the AP may determine whether the probe request contains an authorization token, or whether the probe request does not include an authorization token (e.g., and may be automatically invalid). As another example, if the probing request does include an authorization token, the AP may determine whether the authorization token is valid (e.g., matches, is associated with, etc., the probing BSSID at which the AP receives the probing request).

As another example, the AP may determine whether the probe request was received with a certain validity time (e.g., a time to live), as indicated by the probing data discussed with respect to FIGS. 2-4. As one example, the AP may only accept probing requests at the probing BSSID from a STA for a five second period, while in another example, the AP may accept probing requests at the probing BSSID for fifteen minutes. In some examples the time may be pre-set or otherwise pre-determined, such that the AP is configured to accept probe requests at the probing BSSID regardless of the receipt of an information request, as discussed above. In other examples, the time at which the AP accepts probe requests at the probing BSSID may be determined with respect to the receipt of the information request (e.g., starting at the time of the transmission of the probing data). If the AP does not receive the probing request within the time frame (e.g., the AP receives the probing request after the time frame has elapsed), then the AP may determine that the request is invalid. As another example, the AP may determine whether the probe request was received from a specified source address, as indicated by the probing data discussed with respect to FIGS. 2-4. For example, the AP may respond only to probing requests received from a specific source address, such that if the AP receives a probing request from a different source address, the AP determines that the probing request is invalid.

If the AP determines that the probe request is valid (e.g., successfully validates the probe request), the AP may proceed according to the “YES” branch to block 515. At block 515, the AP, or a component therein (e.g., the response component 213 of FIG. 2) transmits the probe response to the requesting STA. The probe response, as discussed herein, may provide probing information for the STA to use to roam to the AP (or decide whether to roam to the AP), if the STA chooses to. In some examples, the AP may encrypt the probe response using the authorization token included or associated with the probe request. In such examples, in some examples, the authorization token may include a public key associated with the BSS of the neighboring AP to which the probe request is being transmitted, such that encryption occurs according to one or more asymmetric techniques (e.g., using an asymmetric encryption algorithm).

If the AP determines that the probe request is invalid, the AP may proceed according to the “NO” branch to block 520. At block 520, the AP rejects the probe request. In some examples, rejecting the probe request may include the AP refraining from responding to the probe request (e.g., not responding to the probe request). In other examples, rejecting the probe request may include sending a response, wherein the response does not include a probe response. In such examples, in some examples, rejecting the probe request may include transmitting an error message, such as a message indicating why the probe request was determined to be invalid.

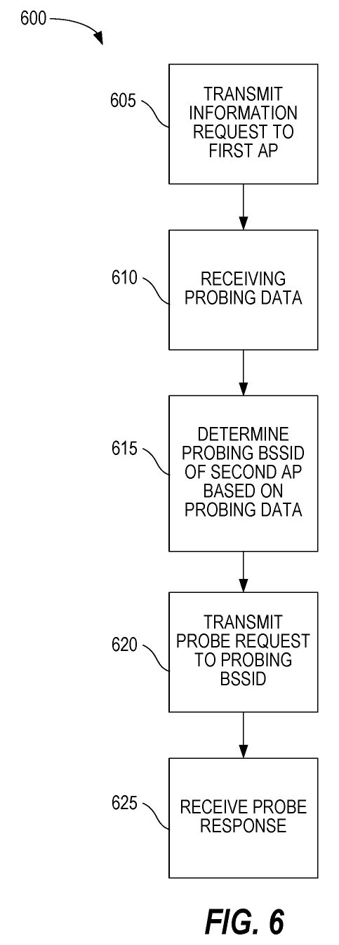

FIG. 6 is a flow diagram depicting an example method for a wireless station to transmit probing requests in a privacy enhanced wireless network, according to some embodiments of the present disclosure. In some embodiments, the method 600 is performed by a STA, such as any of the STAs 115 of FIG. 1 and/or the STA 215 of FIG. 2. FIG. 6 may describe the blocks 305, 325, 330, and 350 of FIG. 3 in greater detail.

At block 605, the STA (e.g., any of the STAs 115 of FIG. 1 and/or the STA 215 of FIG. 2) transmits an information request to a first AP (e.g., any of the APs 110 of FIG. 1 residing in the same BSS 105 as the STA, and/or the AP 210 of FIG. 2). The information request may be, or may include, a neighbor report request, and may generally correspond to a request to receive probing data (e.g., probing information) related to a neighboring AP (e.g., an AP residing in a different BSS than the STA). In some examples, the information request may identify a neighboring AP, while in other examples, the information request may not identify an AP (e.g., such that the receiving AP determines what APs to determine probing data).

At block 610, the STA receives the probing data (e.g., from the first AP). In some examples, the probing data may include an authorization token, which may be included in the probe request to validate the request. In other examples, wherein the probing data does not include in the authorization token, the STA may obtain an authorization token over one or more out-of-band mechanisms, such as obtaining the token from an application, cloud service, and the like. In such examples, in some examples, the STA may obtain the authorization token by proving that the STA is located within a certain distance threshold of the BSS(s) of the neighboring AP that the STA wants to probe. In other examples, wherein the probing data includes a probing BSSID, the STA may calculate the authorization token value directly, based on the probing BSSID. In additional examples, the probing data may include elements such as a validity time or a source address.

At block 615, the STA determines the probing BSSID of the second AP based on the probing data. In some examples, the probing data may include the probing BSSID, to which the STA may transmit a probe request, as discussed below, to a neighboring AP. As such, determining the probing BSSID may include identifying the probing BSSID in the probing data. In other examples, the probing data may not include a probing BSSID. In such examples, the STA may use the authorization token as a key to determine (e.g., compute) the probing BSSID.

At block 620, the STA transmits a probe request to the probing BSSID of the neighboring AP. In some examples, the STA may encrypt the probe request using the authorization token. In such examples, in some examples, the authorization token may include a public key associated with the BSS of the neighboring AP to which the probe request is being transmitted to, such that encryption occurs according to one or more asymmetric techniques (e.g., using an asymmetric encryption algorithm). At block 625, receives a probe response from the neighboring AP, which the STA may use to roam.

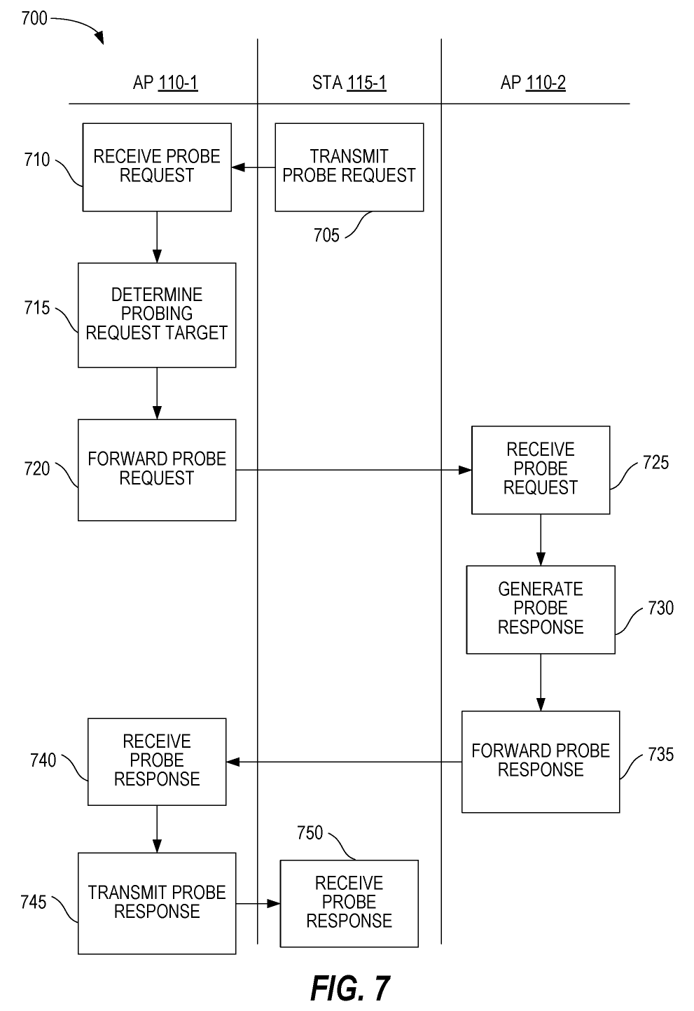

FIG. 7 Is a flow diagram depicting an example method 700 for forwarding probe requests over a distribution system in a privacy enhanced wireless network, according to some embodiments of the present disclosure.

As depicted in FIG. 7, the example method 700 is performed by the AP 110-1, the AP 110-2, and the STA 115-1 of FIG. 1. However, in other examples, the method 700 may be performed by any STA, such as any other STA 115 of FIG. 1 or the STA 215 of FIG. 2, and any two APs residing in separate BSSs (e.g., two different BSSs 105 of FIG. 1). Similarly, as depicted in the example method 700 of FIG. 3, the AP 110-1 is depicted as receiving and forwarding a probing request, while the AP 110-2 is depicted as receiving and responding to the forwarded probe request. However, in other examples, such as when the STA is connected to the AP 110-2 (e.g., any of the STAs 115-2), the AP 110-2 may receive an information receive and forward a probing data a probing request, while the AP 110-1 may receive and respond to the forwarded probe request.

At block 705, the STA 115-1 transmits a probe request to the AP 110-1. The probe request may identify a target AP for the probe request. For example, the STA 115-1 may detect a privacy beacon transmitted by the AP 110-2. In response to detecting the privacy beacon, the STA 115-1 transmits the probe request to the AP that the STA 115-1 is associated with (e.g., the AP 110-1). In some examples, the probe request may be encapsulated in a fast transition (FT) frame (e.g., a FT authentication frame, an FT probing frame, and the like). In some examples, the probe request may include a temporal BSSID of the AP 110-2 (e.g., as detected by the STA 115-1). In such embodiments, in some examples, the probing request includes a timestamp indicating when the temporal BSSID was heard.

At block 710, the AP 110-1 receives the probe request. At block 715, the AP 110-1, or a component therein (e.g., the BPE probing component 112 of FIG. 1 or the probing component 212 of FIG. 2), determines the target AP of the probing request. In the example method 700, the probing request may include a temporal BSSID (e.g., a probing BSSID) for the AP 110-2. For example, the AP 110-1 may read a target destination Media Access Control (MAC) address, such as the temporal BSSID, identified in the probing request. The AP 110-1 may use the temporal BSSID to determine the target of the probe request. For example, the AP 110-1 may determine (e.g., identify) a neighboring AP that broadcasted the temporal BSSID included in the probing request at the timestamp included in the probing request (e.g., in a privacy beacon), such as, in the example method 700, the AP 110-2.

At block 720, the AP 110-1 forwards the probing request to the AP 110-2 (e.g., the target AP) over a distribution system (e.g., an ESS, such as the ESS of FIG. 1). At block 725, the AP 110-2 receives the probing request. At block 730, the AP 110-2 generates a probe response to the probe request and, at block 735, the AP 110-2 forwards the probe response to the AP 110-1. At block 740, the AP 110-1 receives the probe response from the AP 110-2. At block 745, the AP 110-1, or a component therein (e.g., the response component 213 of FIG. 2) and transmits the probe response back to the requesting STA 115-1. In some examples, the AP 110-1 may encrypt the probe response prior to transmitting the probe response to the STA 115-1. At block 750, the STA 115-1 receives a probe response.

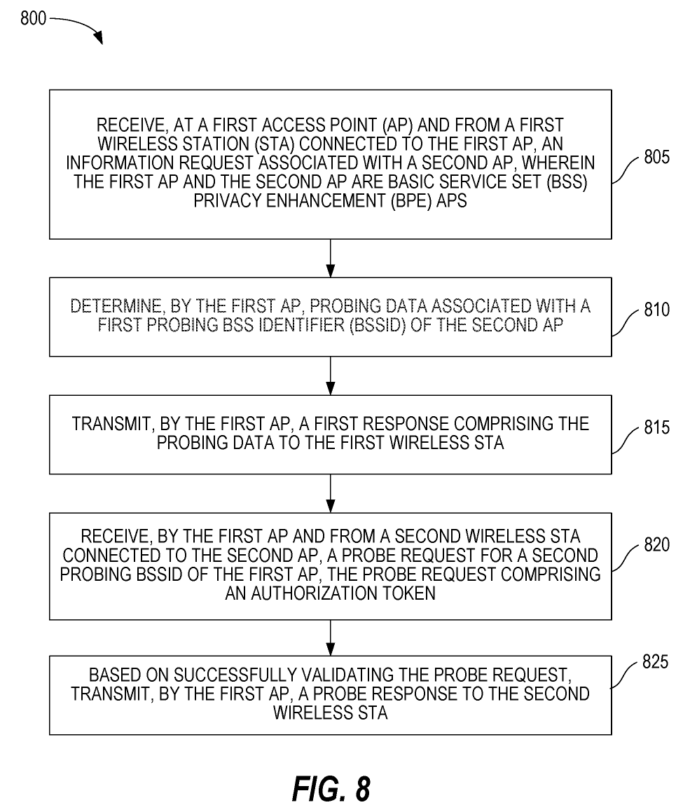

FIG. 8 is a flow diagram depicting an example method 800 for responding to probe requests in a privacy enhanced wireless network, according to some embodiments of the present disclosure. In some embodiments, the method 800 is performed by an AP, such as an AP 110 of FIG. 1 and/or an AP 210 of FIG. 2.

At block 805, a first AP receives, from a first wireless station (STA) connected to the first AP, an information request associated with a second AP, wherein the first AP and the second AP are Basic Service Set (BSS) Privacy Enhancement (BPE) APs. In such embodiments, the operations may correspond to, or provide additional or alternative details for, the operations discussed above with reference to block 310 of FIG. 3 or block 405 of FIG. 4.

At block 810, the first AP determines probing data associated with a first probing BSS identifier (BSSID) of the second AP. In such embodiments, the operations may correspond to, or provide additional or alternative details for, the operations discussed above with reference to blocks 315 of FIG. 3 or block 415 of FIG. 4.

At block 815, the first AP transmits a first response comprising the probing data to the first wireless STA. In such embodiments, the operations may correspond to, or provide additional or alternative details for, the operations discussed above with reference to block 320 of FIG. 3 or block 420 of FIG. 4.

At block 820, the first AP receives, from a second wireless STA connected to the second AP, a probe request for a second probing BSSID of the first AP, the probe request comprising an authorization token. In such embodiments, the operations may correspond to, or provide additional or alternative details for, the operations discussed above with reference to block 505 of FIG. 5.

At block 825, based on successfully validating the probe request, the first AP transmits a probe response to the second wireless STA. In such embodiments, the operations may correspond to, or provide additional or alternative details for, the operations discussed above with reference to blocks 510 and 515 of FIG. 5.

In some examples, the probing data includes a second authorization token. In such embodiments, in some examples, the second authorization token comprises a key used to determine the first probing BSSID of the second AP.

In some examples, the probing data includes the first probing BSSID.

In some examples, the probing data includes a validity time indicating a duration of time during which the first probing BSSID is valid.

In some examples, the operation at block 825 of validating the probe request comprises validating the authorization token. In such embodiment, in some examples, the probing data includes a source address, and validating the probe request further comprises determining that the probe request is received from the source address. In such embodiments, the operations may correspond to, or provide additional or alternative details for, the operations discussed above with reference to block 410 of FIG. 4.

In some examples, the authorization token includes a key, wherein the key is used to encrypt the probe request and the probe response.

In some examples, the operation at block 815 of transmitting the first response comprises determining, by the first AP, a location of the first wireless STA in an Extended Service Set (ESS) comprising at least the first AP and the second AP. In such embodiments, the first AP determines a threshold radius for the second AP and, in response to determining that the location of the first wireless STA falls within the threshold radius, transmits the first response. In such embodiments, the operations may correspond to, or provide additional or alternative details for, the operations discussed above with reference to blocks 410, 415, and 420 of FIG. 4.

Additionally, in such embodiments, in some examples, the operations further include receiving, at the first AP and from a third wireless STA connected to the first AP, a second information request associated with the second AP. In such embodiment, the first AP determines a second location of the third wireless STA in the ESS and, in response to determining that the second location of the third wireless STA does not fall within the threshold radius for the second AP, refrains from transmitting a second set of probing data. In such embodiments, the operations may correspond to, or provide additional or alternative details for, the operations discussed above with reference to blocks 410 and 425 of FIG. 4.

In some examples, the operations of the example method 800 includes receiving, at the first AP and from a third wireless STA connected to the second AP, a second probe request for the second probing BSSID of the first AP, the probe request comprising a second authorization token. In such embodiments, based on determining that the probe request is invalid, the first AP refrains from transmitting a second probe response to the third wireless STA. In such embodiments, the operations may correspond to, or provide additional or alternative details for, the operations discussed above with reference to block 520 of FIG. 5.

In some examples, the operations of the example method 800 includes receiving, at the first AP, a second probe request from a third wireless STA connected to the first AP, wherein the second probe request includes a third probing BSSID of the second AP. In such embodiments, the first AP determines, based on the second probe request, that the probe request is associated with the second AP, and forwards the second probe request to the second AP over a distribution system. The first AP receives a second probe response from the second AP and transmits the second probe response to the third wireless STA. In such embodiments, in some examples, the second probe request further includes a timestamp, wherein determining that the second probe request is associated with the second AP comprises determining, by the first AP, that the second AP broadcasted a privacy beacon including the third probing BSSID at a time indicated by the timestamp. In such embodiments, the operations may correspond to, or provide additional or alternative details for, the operations discussed above with reference to block 705-750 of FIG. 7.

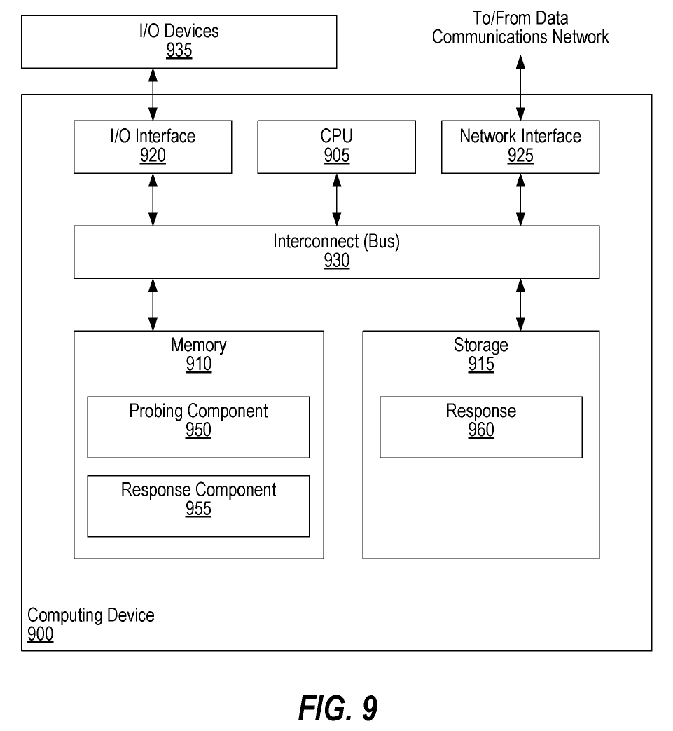

FIG. 9 depicts an example network device 900 configured to perform various embodiments of the present disclosure. Although depicted as a physical device, in embodiments, the computing device 900 may be implemented using any number of virtual or physical device(s) (e.g., in a cloud environment). In one embodiment, the computing device 900 corresponds to or implements an AP, such as any of the APs 110 or the AP 210 of FIGS. 1 and 2, respectively, or the APs discussed above with reference to FIGS. 3-8.

As illustrated, the computing device 900 includes a CPU 905, a memory 910, a storage 915, a network interface 925, and one or more I/O interfaces 920. In the illustrated embodiment, the CPU 905 retrieves and executes programming instructions stored in the memory 910, as well as stores and retrieves application data residing in the memory 910, the storage 915, or both. The CPU 905 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 935 (such as keyboards, monitors, etc.) are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, the memory 910, the network interface(s) 925, and the I/O interface(s) 920 are communicatively coupled by one or more buses 930.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 is generally included to be representative of a random-access memory. The memory 910 may store processor-executable software code containing instructions that, when executed by the CPU 905, enable the computing device 900 to perform various functions described herein for wireless communication. The memory 910 may include random access memory (RAM) and read-only memory (ROM).

As depicted, the memory 910 includes a probing component 950 and a response component 955. Although depicted as discrete components for conceptual clarity, in embodiments, the operations of the depicted components (and others not illustrated) may be combined or distributed across any number of components. Further, although depicted as software residing in the memory 910, in embodiments, the operations of the depicted components (and others not illustrated) may be implemented using hardware, software, or a combination of hardware and software.

The probing component 950 may generally correspond, and operate in a similar manner to, the BPE probing component 112 of any of the APs 110 of FIG. 1 or the probing component 212 of the AP 210 of FIG. 2. In some examples, the probing component 950 may be configured to determine probing data for one or more neighboring APs, such as a probing BSSID of a neighboring AP, an authorization token used to determine and/or query the probing BSSID, a validity time at which probe requests may be transmitted to the probing BSSID, a source address to send a probe request to the probing BSSID from, and the like. In other examples, the probing component 950 may be configured to generate probe request data, in response to receiving a query (e.g., a probe request). after validating the query, such as by validating an authorization token or determining whether the query is from a specific source address. In further examples, the probing component 950 determines the target AP of a probing request, and forwards the probing request to the target AP. In such examples, the probing component 950 may forward the probe response received from the target AP to the requestor (e.g., a STA).

The response component 955 may generally correspond, and operate in a similar manner to, the response component 213 of the AP 210 of FIG. 2. The response component 955 may generate one or more responses, such as the response 960, to one or more STAs (e.g., any of the STAs 115 or the STA 215 of FIGS. 1 and 2, respectively), providing the STA with information on neighboring APs of the same ESS of the STA. For example, the response component may encode or otherwise generate one or more frames, such as wireless management frame, operating as or included in the response 960, with data, such as the probing data or the probe request response, as discussed above. The computing device 900 may transmit the response 960, to a STA, as described above. Although depicted as residing in the storage 915, the response 960 of the computing device 900 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, at a first access point (AP) and from a first wireless station (STA) connected to the first AP, an information request associated with a second AP, wherein the first AP and the second AP are Basic Service Set (BSS) Privacy Enhancement (BPE) APs;
determining, by the first AP, probing data associated with a first probing BSS identifier (BSSID) of the second AP;
transmitting, by the first AP, a first response comprising the probing data to the first wireless STA;
receiving, at the first AP from a second wireless STA connected to the second AP, a probe request for a second probing BSSID of the first AP, the probe request comprising an authorization token; and
based on successfully validating the probe request, transmitting, by the first AP, a probe response to the second wireless STA.

2. The method of claim 1, wherein the probing data includes a second authorization token.

3. The method of claim 1, wherein the probing data includes the first probing BSSID.

4. The method of claim 1, wherein the probing data includes a validity time indicating a duration of time during which the first probing BSSID is valid.

5. The method of claim 1, wherein validating the probe request comprises validating the authorization token.

6. The method of claim 5, wherein the probing data includes a source address, and wherein validating the probe request further comprises determining that the probe request is received from the source address.

7. The method of claim 1, transmitting the first response comprises:
determining, by the first AP, a location of the first wireless STA in an Extended Service Set (ESS) comprising at least the first AP and a second AP;
determining a threshold radius for the second AP; and
in response to determining that the location of the first wireless STA falls within the threshold radius, transmitting the first response.

8. The method of claim 7, further comprising:
receiving, at the first AP and from a third wireless STA connected to the first AP, a second information request associated with the second AP;
determining, by the first AP, a second location of the third wireless STA in the ESS; and
in response to determining that the second location of the third wireless STA does not fall within the threshold radius for the second AP, refraining from transmitting a second set of probing data.

9. The method of claim 1, further comprising:
receiving, at the first AP and from a third wireless STA connected to the second AP, a second probe request for the second probing BSSID of the first AP, the probe request comprising a second authorization token; and
based on determining that the probe request is invalid, refraining from transmitting, by the first AP, a second probe response to the third wireless STA.

10. The method of claim 1, further comprising:
receiving, at the first AP, a second probe request from a third wireless STA connected to the first AP, wherein the second probe request includes a third probing BSSID of the second AP;
determining, by the first AP and based on the second probe request, that the probe request is associated with the second AP;
forwarding, by the first AP, the second probe request to the second AP over a distribution system;
receiving, at the first AP, a second probe response from the second AP; and
transmitting, by the first AP, the second probe response to the third wireless STA.

11. The method of claim 10, wherein the second probe request further includes a timestamp, and wherein determining that the second probe request is associated with the second AP comprises determining, by the first AP, that the second AP broadcasted a privacy beacon including the third probing BSSID at a time indicated by the timestamp.

12. An access point (AP) comprising:
one or more memories; and
one or more processors communicatively coupled to the one or more memories, wherein the one or more processors are configured to, individually or collectively, perform operations comprising:
receiving, from a first wireless station (STA) connected to the AP, an information request associated with a second AP, wherein the AP and the second AP are Basic Service Set (BSS) Privacy Enhancement (BPE) APs;
determining probing data associated with a first probing BSS identifier (BSSID) of the second AP;
transmitting a first response comprising the probing data to the first wireless STA;
receiving, from a second wireless STA connected to the second AP, a probe request for a second probing BSSID of the AP, the probe request comprising an authorization token; and
based on successfully validating the probe request, transmitting a probe response to the second wireless STA.

13. The AP of claim 12, wherein transmitting the first response comprises:
Determining a location of the first wireless STA in an Extended Service Set (ESS) comprising at least the AP and the second AP;
determining a threshold radius for the second AP; and
in response to determining that the location of the first wireless STA falls within the threshold radius, transmitting the first response.

14. The AP of claim 13, further comprising:
receiving, from a third wireless STA connected to the AP, a second information request associated with the second AP;
determining a second location of the third wireless STA in the ESS; and
in response to determining that the second location of the third wireless STA does not fall within the threshold radius for the second AP, refraining from transmitting a second set of probing data.

15. The AP of claim 12, further comprising:
receiving, from a third wireless STA connected to the second AP, a second probe request for the second probing BSSID of the AP, the probe request comprising a second authorization token; and
based on determining that the probe request is invalid, refraining from transmitting a second probe response to the third wireless STA.

16. The AP of claim 12, further comprising:
receiving a second probe request from a third wireless STA connected to the AP, wherein the second probe request includes a third probing BSSID of the second AP;
determining, based on the second probe request, that the probe request is associated with the second AP;
forwarding the second probe request to the second AP over a distribution system;
receiving a second probe response from the second AP; and
transmitting the second probe response to the third wireless STA.

17. A non-transitory computer readable storage medium comprising instructions that when executed configure one or more processors of an access point to perform operations comprising:
receiving, at a first access point (AP) and from a first wireless station (STA) connected to the first AP, an information request associated with a second AP, wherein the first AP and the second AP are Basic Service Set (BSS) Privacy Enhancement (BPE) APs;
determining, by the first AP, probing data associated with a first probing BSS identifier (BSSID) of the second AP;
transmitting, by the first AP, a first response comprising the probing data to the first wireless STA;
receiving, from a second wireless STA connected to the second AP, a probe request for a second probing BSSID of the first AP, the probe request comprising an authorization token; and
based on successfully validating the probe request, transmitting, by the first AP, a probe response to the second wireless STA.

18. The non-transitory computer readable storage medium of claim 17, wherein transmitting the first response comprises:
determining, by the first AP, a location of the first wireless STA in an Extended Service Set (ESS) comprising at least the first AP and the second AP;
determining a threshold radius for the second AP; and
in response to determining that the location of the first wireless STA falls within the threshold radius, transmitting the first response.

19. The non-transitory computer readable storage medium of claim 18, further comprising:
receiving, at the first AP and from a third wireless STA connected to the first AP, a second information request associated with the second AP;
determining, by the first AP, a second location of the third wireless STA in the ESS; and
in response to determining that the second location of the third wireless STA does not fall within the threshold radius for the second AP, refraining from transmitting a second set of probing data.

20. The non-transitory computer readable storage medium of claim 17, further comprising:
receiving, at the first AP and from a third wireless STA connected to the second AP, a second probe request for the second probing BSSID of the first AP, the probe request comprising a second authorization token; and
based on determining that the probe request is invalid, refraining from transmitting, by the first AP, a second probe response to the third wireless STA.
